(19) United States
(12) Patent Application Publication
(10) Pub. No.: US 2026/0164115 A1
(43) Pub. Date: Jun. 11, 2026

(54) Method for Displaying at Least One Specific Area in a Thermal Image of a Thermal Imaging Camera

(71) Applicant: Robert Bosch GmbH, Stuttgart (DE)

(72) Inventors: Axel Rumberg, Karlsruhe (DE); Ina Sophie Boettcher, Simmersfeld (DE); Kilian Hutzler, Stuttgart (DE); Michael Frank, Bretten (DE); Patrick Meyer, Leinfelden-Echterdingen (DE); Tim Saup, Leinfelden-Echterdingen (DE)

(21) Appl. No.: 19/406,024

(22) Filed: Dec. 2, 2025

(30) Foreign Application Priority Data
Dec. 5, 2024 (DE) 10 2024 211 630.0

(51) Int. Cl. H04N 23/63; G01J 5/00; G01J 5/08; G06T 7/13; G06T 7/90; H04N 23/11; H04N 23/62; H04N 23/67

(52) U.S. Cl. CPC H04N 23/632; G01J 5/0859; G06T 7/13; G06T 7/90; H04N 23/11; H04N 23/62; G01J 2005/0077; G06T 2207/10024; G06T 2207/10048; G06T 2207/20092; H04N 23/67

(57) ABSTRACT

A method for displaying at least a specific area in a thermal image of a thermal imaging camera includes (i) providing the thermal image, wherein the thermal image results from a detection of a thermal image sensor of the thermal imaging camera, (ii) receiving at least one selection condition for the specific range in the thermal image based on a user input, (iii) creating the specific area based on the received selection condition, (iv) determining a color scale for the specific area created based on a minimum and a maximum temperature value represented in the specific area created in the thermal image, and (v) initiating a display of a blended image, wherein the blended image comprises the specific area created using the determined color scale as a thermal image and a remaining area. Also disclosed are a thermal imaging camera, a computer program, a device, and a storage medium for this purpose.

This application claims priority under 35 U.S.C. § 119 to patent application no. DE 10 2024 211 630.0, filed on Dec. 5, 2024 in Germany, the disclosure of which is incorporated herein by reference in its entirety.

The disclosure relates to a method for displaying at least one specific area in a thermal image of a thermal imaging camera. The disclosure further relates to a thermal imaging camera, a computer program, a device, and a storage medium for this purpose.

### BACKGROUND

A thermal image is usually presented over an entire captured image detail of a display of a thermal imaging camera. The associated color scale typically includes all temperatures of the captured image detail from a minimum to a maximum. The range from the minimum temperature in the image to the maximum temperature is referred to as “span” and the color scale is divided linearly from the coldest temperature to the warmest temperature. In current thermal imaging cameras, there are other modes for rendering the image. In the picture-in-picture mode, only a part of the image is shown as a thermal image in the display of the thermal camera, the (surrounding) rest is the image of a visual camera that is present today in many thermal imaging cameras. The image detail, which is shown as a thermal image, is predetermined, i.e., not adjustable by the user. The span further includes all temperatures present in the overall image. In transparent mode, the image of the visual camera is placed “behind” the entire thermal image. This is referred to as alpha blending. In “hotseeker” mode, only temperatures from a user-determinable temperature are represented as a thermal image, everything else is represented as a visual image. In “coldseeker” mode, the user sets a temperature up to which the image is displayed as a thermal image, over which the visual image is displayed. In a manual mode, the temperature span may also be adjustable, i.e., the user may define upper and lower thresholds above and below which the image is only displayed in a single-color. Only for the temperature range in between are the colors present in the scale then divided.

### SUMMARY

The subject-matter of the disclosure is a method, a thermal imaging camera, a computer program, and a computer-readable storage medium having the features set forth below. Further features and details of the disclosure will emerge from the description and the drawings. Features and details which are described in connection with the method according to the disclosure naturally also apply in connection with the thermal imaging camera according to the disclosure, the computer program according to the disclosure, and the computer-readable storage medium according to the disclosure, and vice versa in each case, so that a reciprocal reference is always possible with regard to the disclosure of the disclosure.

The object of the disclosure is in particular a method for displaying at least one specific area in a thermal image of a thermal imaging camera, comprising:
providing the thermal image, wherein the thermal image results from capturing by a thermal image sensor, for example an infrared detector array, of the thermal imaging camera, wherein the thermal image is also synonymously referred to as a thermo image or infrared image and can be understood, which in particular applies analogously to the thermal image sensor and the thermal imaging camera,
receiving at least one selection condition for the specific area in the thermal image based on a user input,
creating the specific area based on the received selection condition,
determining a color scale for the specific area created based on a minimum and maximum temperature value represented in the specific area created in the thermal image, wherein which it is also contemplated that temperature values defined are added to and/or subtracted from the minimum and/or maximum temperature value (simplified in terms, e.g., Min−x and Max+x or Min+x and Max−x are also possible, wherein x are the defined temperature values, for example, 5° C.),
initiating a display of a blended image, for example on a display of the thermal camera, wherein the blended image comprises the specific area created using the particular color scale as a thermal image and a remaining area, wherein it is also contemplated.
   In other words, the color scale for the specific area created determines the colors to display. The method according to the disclosure allows a user-defined thermal image to be generated that focuses on a selected area, i.e., the specific area, and whose color scale is adapted to the temperatures in that area. This method in particular allows a more detailed analysis of the thermal image in the specific area and can improve the contrast in that area.

It is further contemplated that creating comprises:
determining color information and/or temperature information in the thermal image for the at least one selection condition received.
   This allows the color scale to be precisely matched to the specific area. The analysis of the color information and temperature information allows a fine tuning of the color palette to the temperatures present in this area. This in particular leads to an improved representation of the temperature differences within the specific area.

In addition, it is conceivable in the context of the disclosure that the remaining area corresponds to a gray-scale representation of a corresponding portion of the thermal image. This allows the blended image display to clearly distinguish between the focused specific thermal image area and the remaining area. The limited color spectrum of the gray scale representation in the remaining area may advantageously additionally highlight the specific thermal image area and thus support the visual analysis.

Optionally, it may be provided that the method may further comprise:
providing a visual image, wherein the visual image results from an acquisition of a camera sensor, particularly a visual camera sensor, of the thermal camera, wherein the thermal image and the visual image represent a same captured scene,
   wherein the remaining area corresponds to a corresponding portion of the visual image and/or wherein the specific area after performing alpha blending is an overlay of the thermal image and the visual image. This allows the display of the blended image to provide the user with an improved understanding of the captured scene. The combination of thermal image and visually captured image provides a more comprehensive representation in particular as both temperature information and visual details are displayed. This may be particularly helpful for applications where it is important to look at both aspects of a scene.

Moreover, it is advantageous for the user input to be on a display, in particular a touch sensitive display, and/or on a control element of the thermal imaging camera in the context of the disclosure. In other words, this may allow the user to define the specific area in the thermal image via various input prompts, such as a display, in particular a touch sensitive display, or via control elements on the thermal imaging camera. This may increase flexibility and usability of the thermal imaging camera.

In addition, it is advantageous for the selection condition to be a rectangle or a free-form, with the specific area corresponding to a content of the rectangle or free-form. This allows the user to precisely define the desired region in the thermal image. The flexibility in the selection of the area allows more detailed analysis of specific zones in particular, and can increase contrasts within the specific area. This leads to more efficient visualization and interpretation of the thermal images. Further shapes, such as a circle, are also contemplated.

It may further be possible for the selection condition to be at least one selected object represented in the thermal image or in the visual image, wherein creating comprises the following step:
detecting boundaries of the at least one selected object in the thermal image or in the visual image based on image recognition, in particular segmentation, wherein the specific area corresponds to content of the detected boundaries.
   In other words, the user may select at least one object shown in the thermal image or the visual image and the specific area is created based on this object representation. Detecting the boundaries may be performed using a segmentation algorithm or, for example, a machine learning model. In this way, the user may focus the thermal image representation on one or more particular objects and the color scale may be automatically adjusted to the temperatures within that object or objects. This allows, for example, a detailed analysis of specific elements in the thermal image. The image recognition technique may represent an intuitive and user-friendly method of selecting the area, since the user may simply select the at least one desired object.

In another option, the user input may be provided to be a manual or automatic focus based on the thermal image and/or the visual image, wherein the selection condition is a resulting focused area, wherein the creation comprises the following step:
analyzing the resulting focused area to identify a sharp area, the specific area corresponding to the identified sharp area.
   In particular, this achieves that the selection of the thermal image area is precise and aligned with the focus of the user. For example, the automatic or manual focus allows the user to selectively highlight areas that require detailed analysis.

A sharp area in an image is, in particular, an area where image details are clear and well defined. This means, for example, that edges, textures and fine structures are clearly visible and have no blurring. For example, sharpness may be measured by an analysis of gradients in the image. Gradients particularly describe how quickly the intensity values (brightness) change. A high gradient may indicate a sharp edge. For example, algorithms such as the Sobel or Canny detector may be used to determine edges. The laplacian is a second derivative operator that identifies edges and regions with high intensity changes. An image with many pronounced laplacian values may indicate sharp areas. A sharp area includes in particular a greater number of high spatial frequencies. The Fourier transformation can be used to analyze the frequency components of an image. An image with many high spatial frequency components tends to be sharper in particular. Visual inspection may be performed to determine whether an area has fine details and sharp edges. Furthermore, sharp areas tend to have higher contrast differences between adjacent pixels.

Algorithms may be used to analyze the resulting focused area analyzing texture and edge information. Furthermore, a trained machine learning model may be used to automatically classify sharp and blurred areas.

It may be advantageous if the disclosure provides that the method further comprises:
determining at least one further specific area in the thermal image that is within the minimum and maximum temperature value, in particular based on temperature information of the thermal image,
   wherein, as part of initiating the display of the blended image, the blended image further comprises the determined at least one further specific area using the determined color scale as a thermal image and a corresponding adjusted remaining area. In other words, further specific areas in the blended image can thus be represented as thermal images that are also in the range between the minimum and maximum temperature value of the specific area created. The remaining area is preferably made smaller according to the further specific areas.

The subject matter of the disclosure is also a thermal imaging camera comprising:
A data processing device configured to perform the method according to the disclosure, wherein the data processing device is, for example, an integrated circuit or microprocessor or a comparable device,
A thermal image sensor, for example an infrared detector array, wherein the thermal image sensor is configured to capture a thermal image,
A camera sensor, in particular a visual camera sensor, wherein the camera sensor is configured to capture a visual image,
A display, in particular a touch sensitive display, and at least one control element, wherein the display and/or the at least one control element are configured to detect a user input, wherein the display is further configured to display the blended image.
   The thermal imaging camera according to the disclosure thus has the same advantages as those described in detail with reference to the method according to the disclosure.

Another object of the disclosure is a computer program, in particular a computer program product, comprising instructions which, when the computer program is executed by at least one computer, cause the computer to carry out the method according to the disclosure. The computer program according to the disclosure thus brings with it the same advantages as have been described in detail with reference to a method according to the disclosure.

The disclosure also relates to a device for data processing which is configured so as to carry out the method according to the disclosure. The device can be at least one computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or commands that, when executed by at least one computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method. Alternatively or additionally, at least one of the disclosed method steps may be computer-implemented and/or performed automatically.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. It shows:

FIG. 1 a schematic visualization of a thermal imaging camera according to exemplary embodiments of the disclosure,

FIG. 2 a schematic illustration of a thermal imaging camera according to exemplary embodiments of the disclosure,

FIG. 3 a schematic visualization of a method, a device, a storage medium and a computer program according to exemplary embodiments of the disclosure, and

FIG. 4 a schematic visualization of a method according to exemplary embodiments of the disclosure.

### DETAILED DESCRIPTION

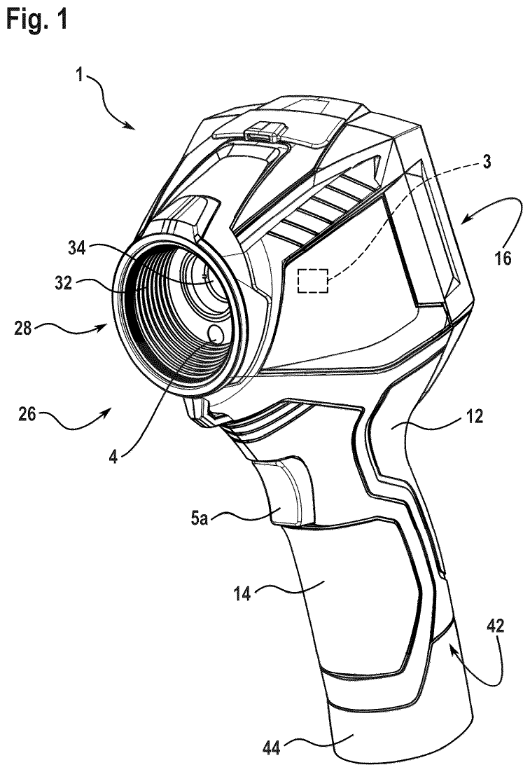

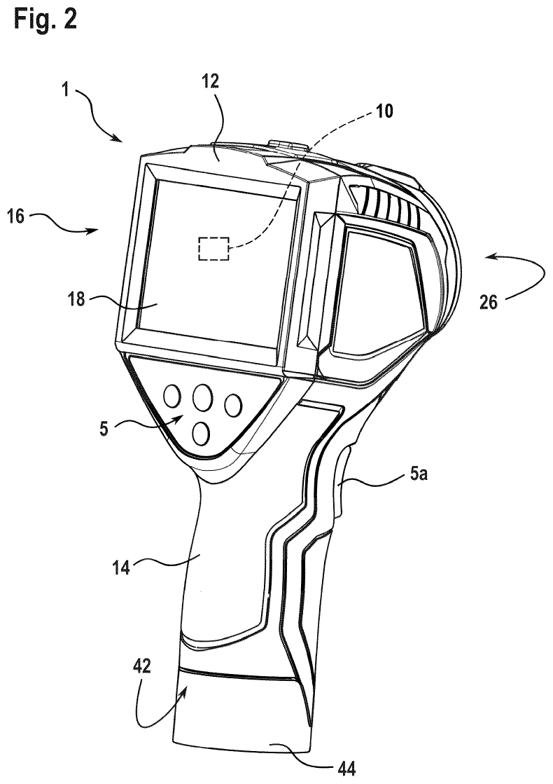

With reference to FIG. 1 and FIG. 2, a thermal imaging camera 1 according to exemplary embodiments of the disclosure, in particular in the form of a handheld thermal imaging camera 1, is described below. FIG. 1 and FIG. 2 show an exemplary embodiment of this thermal imaging camera 1 in a perspective front view and a perspective rear view, respectively. The thermal imaging camera 1 comprises a housing 12 with a handle 14. Using the handle 14, the thermal imaging camera 1 can be conveniently held in one hand during use. The housing 12 of the thermal imaging camera 1 also has, on a side 16 facing the user during use of the thermal imaging camera 1, an output device in the form of a display 18, in particular a touch screen 18, and control elements 5 for user input and control of the thermal imaging camera 1. In particular, the thermal imaging camera 1 comprises a trigger 5a, with which a user can trigger a contact-free determination of a temperature of a surface of an object to be examined, in particular a temperature distribution of a surface of an object.

On the side of the housing 12 facing away from a user 26, an entry opening 28 is provided in the housing 12 through which thermal radiation emitted by the object 24, in particular emitted in a measuring area from a surface 22 of the object 24, can enter the thermal imaging camera 1. Immediately behind the inlet opening 28, a lens system 34 is located in a light tube that reduces scattered light and acts as an optical element. The lens system 34 is permeable to infrared radiation and serves, for example, to focus thermal radiation on a thermal image sensor 3, in particular an infrared detector array, of the thermal imaging camera 1.

On the side 26 facing away from the user of the housing 12 during use of the thermal imaging camera 1, a camera sensor 4, which operates in the visual spectrum, is further provided in an exemplary embodiment of the thermal imaging camera 1, by way of which a visual image of the measured area can be captured. These visual images can be output together with a thermal image generated from a temperature measurement initiated by the user, in particular, according to exemplary embodiments of the disclosure, at least partially superimposed or blended with the thermal image as the blended image. The camera sensor 4 can be realized as a CCD image sensor, for example.

On the underside of the thermal imaging camera 1, the handle 14 also has a receptacle 42 for accommodating an energy storage device 44, which can be in the form of a rechargeable accumulator or in the form of batteries, for example.

Further, the thermal imaging camera 1 comprises a device 10 for data processing as shown schematically in FIG. 2.

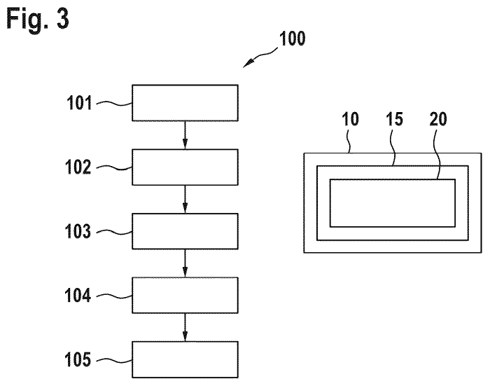

FIG. 3 schematically illustrates a method 100, a device 10, a storage medium 15, and a computer program 20 according to exemplary embodiments of the disclosure.

In particular, FIG. 3 shows an exemplary embodiment for a method 100 to display at least a specific area in a thermal image of a thermal imaging camera 1. In a first step 101, the thermal image is provided, wherein the thermal image results from detecting a thermal image sensor 3 of the thermal imaging camera 1. In a second step 102, at least one selection condition for the specific range in the thermal image is received based on a user input. In a third step 103, the specific range is created based on the received selection condition. In a fourth step 104, a color scale for the specific area created is determined based on a minimum and maximum temperature value represented in the specific area created in the thermal image. In a fifth step 105, a display of a blended image is initiated, wherein the mixed image comprises the specific area created using the particular color scale as a thermal image and a remaining area.

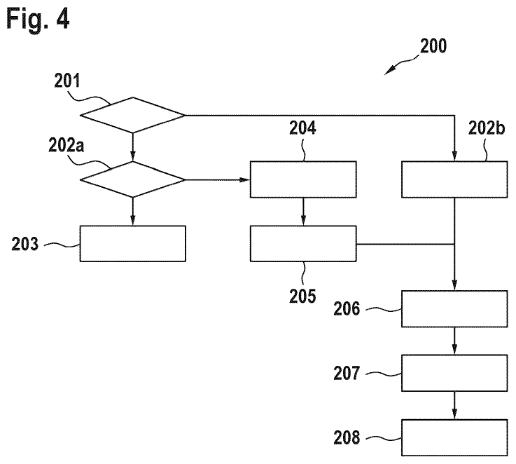

FIG. 4 shows a method 200 according to an exemplary embodiment of the disclosure. In a step 201 in particular, it is determined whether a user input was made using the touch sensitive display 18 of the thermal imaging camera 1. If not, it is preferably determined according to step 202 whether a user input is in the form of a focus. If this is also not the case, the method may be ended according to step 203. If the user input is via the touch sensitive display 18 of the thermal imaging camera 1, the specific area is preferably created as a rectangle or a free-form in accordance with step 202b. If the user input is in the form of focusing, the user focuses a desired image area or object depicted in the thermal image, in particular according to step 204. Then, according to step 205, the specific area according to the disclosure may be created as a sharp area of focus. According to step 206, there can then be an automatic determination of a minimum and a maximum temperature value in the specific range. Then, according to step 207, a color scale may be constrained to a range between the minimum and maximum temperature value. Lastly, according to step 208, a mixed image may be displayed, wherein the mixed image comprises the specific area using the color scale as the thermo image and a remaining area as the gray-scale thermo image or as the visual image.

According to exemplary embodiments of the disclosure, the area represented as a thermal image may be selected by a user in terms of size. That is to say, in contrast to the picture-in-picture mode, the area displayed as a thermal image is adaptive in particular. Thus, the user may “tailor” the area to be displayed. In addition, in the picture-in-picture mode according to the prior art, there is in particular the problem that a span, i.e. a range from a minimum to a maximum temperature value, still covers all temperatures present in the entire image, i.e. the color scale in the picture-in-picture detail is particularly based on the span of the entire image. According to exemplary embodiments of the disclosure, the span may be adjusted to the specific range chosen by the user, i.e., the color scale in particular comprises only temperatures within the specific range selected. The selected specific range can thus be advantageously shown to be more contrast-rich.

By way of a touchscreen display 18 or control elements 5, the user can draw a rectangle in which the thermal image is to be displayed, for example. The color scale is preferably automatically subsequently adjusted to this area, i.e. the coldest and the warmest point are preferably determined and introduced as boundaries of the color scale. The remainder of the mixed image may then be represented, e.g., either as a visual image or as a gray-graded thermal image. It is also possible to limit the area to an object-by-object detection in the visual image or in the thermal image. A further possibility for determining the area shown as a thermal image is in particular to focus a specific area, which is e.g. in the foreground, by way of a focusable optic. Only the “sharp” region would then preferably be represented as a thermal image and the color scale may be adjusted as described above.

According to one option, the determination of the specific area can accordingly be carried out by way of a touch sensitive display 18 or control elements 5. The user may define a rectangle or also a free-form area within which he or she would like the thermal image to be displayed by way of the touch-sensitive display 18 or the control elements 5. It could also be possible to define the area by selecting an object in the visual or thermal image. For example, the user clicks on a representation of an object on the touch sensitive display 18, and boundaries of the representation of the object may be detected by image recognition. The specific range is preferably limited to this object representation. Then, it is preferably automatically determined which temperatures are present in this image detail and the color scale is circumscribed accordingly.

According to another possibility, the specific range may be determined by focusing. The precondition here is in particular a presence of a focusable optic, i.e. the focus must preferably be manually or automatically adjustable. Here, the user can focus the image on an object or area of the image they select. Then, in particular, it is automatically detected where the image is sharp and the representation of the thermal image is limited to that sharp area. Then, it is preferably automatically determined which temperatures are present in this image detail and the color scale is circumscribed accordingly.

According to further option, a determination of a temperature range may be performed. In this alternative, the user can select a section from the thermal image. Preferably, the maximum and the minimum temperature are extracted from this section. In the blended image, sections that lie within this temperature range are subsequently shown as a thermal image. The rest of the image is preferably presented as a gray-scale representation or visual image.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for displaying at least one specific area in a thermal image of a thermal imaging camera, comprising:
providing the thermal image, wherein the thermal image results from a detection of a thermal image sensor of the thermal imaging camera;
receiving at least one selection condition for the specific range in the thermal image based on a user input;
creating the specific area based on the received selection condition;
determining a color scale for the specific area created based on a minimum and a maximum temperature value represented in the specific area created in the thermal image; and
initiating a display of a blended image, wherein the mixed image comprises the specific area created using the determined color scale as a thermal image and a remaining area.

2. The method according to claim 1, wherein the creating step comprises determining color information and/or temperature information in the thermal image for the at least one selection condition received.

3. The method according to claim 1, wherein the remaining area corresponds to a gray level representation of a corresponding portion of the thermal image.

4. The method according to claim 1, further comprising providing a visual image, wherein the visual image results from a capture of a camera sensor of the thermal imaging camera, and the thermal image and the visual image represent a same captured scene, and
wherein the remaining area corresponds to a corresponding portion of the visual image and/or wherein the specific area after performing alpha blending is an overlay of the thermal image and the visual image.

5. The method according to claim 1, wherein the user input is an input on a display and/or on a control element of the thermal imaging camera.

6. The method according to claim 5, wherein:
the selection condition is a rectangle or a free-form, and
the specific area corresponds to a content of the rectangle or the free-form.

7. The method according to claim 5, wherein the selection condition is at least one selected object represented in the thermal image or in the visual image, and wherein the creating step comprises:
detecting boundaries of the at least one selected object in the thermal image or in the visual image based on image recognition, and wherein the specific area corresponds to content of the detected boundaries.

8. The method according to claim 1, wherein the user input is a manual or automatic focus based on the thermal image and/or the visual image, wherein the selection condition is a resulting focused area, and wherein the creating step comprises:
analyzing the resulting focused area to identify a sharp area, the specific area corresponding to the identified sharp area.

9. The method according to claim 1, further comprising determining at least one further specific area in the thermal image that is within the minimum and maximum temperature value based on temperature information of the thermal image, wherein:
as part of the step of initiating the display of the blended image, the blended image further comprises the at least one further specific area determined using the determined color scale as a thermal image and a corresponding adjusted remaining area.

10. A thermal imaging camera, comprising:
a device for data processing configured to carry out the method according to claim 1;
a thermal image sensor configured to capture a thermal image;
a camera sensor configured to capture a visual image; and
a display and at least one control element, wherein the display and/or the at least one control element are configured to capture user input, wherein the display is further configured to display the blended image.

11. A computer program, comprising instructions which, when the computer program is executed by at least one computer, cause the latter to execute the method according to claim 1.

12. A computer-readable storage medium, comprising instructions which, when executed by at least one computer, cause the computer to carry out the steps of the method according to claim 1.

13. The method according to claim 5, wherein the selection condition is at least one selected object represented in the thermal image or in the visual image, and wherein the creating step comprises:
detecting boundaries of the at least one selected object in the thermal image or in the visual image based on image segmentation, and wherein the specific area corresponds to content of the detected boundaries.
